(19) United States
(12) Patent Application Publication
(10) Pub. No.: US 2004/0110109 A1
(43) Pub. Date: Jun. 10, 2004

(54) Device for relocating a lower jaw relative to an upper jaw

(76) Inventor: Rolf Forster, Pforzheim (DE)

Correspondence Address: LADAS & PARRY, 224 SOUTH MICHIGAN AVENUE, SUITE 1200, CHICAGO, IL, 60604, US

(21) Appl. No.: 10/427,204

(22) Filed: Apr. 30, 2003

(30) Foreign Application Priority Data
May 3, 2002 (DE) 202 07 402.1
May 25, 2002 (DE) 202 08 187.7
Jun. 13, 2002 (DE) 202 09 178.3

(51) Int. Cl. A61C 3/00

(52) U.S. Cl. 433/19

(57) ABSTRACT

A device for relocating a lower jaw relative to an upper jaw. The device is telescopically extensible and is a kind of a Herbst hinge, including a holder with an eye mounted on each of its two ends. The device can be mounted in articulated fashion, for example on a molar strip in the upper jaw and on a molar strip in the lower jaw. The molar strip is usually provided for this purpose with a counter-holder with an internal thread into which a head screw can be screwed through the respective holder of the device, the articulated connection being realized by the fact that either the shaft of the head screw or a shaft engages the eye of the device so as to permit the latter to rotate about the respective shaft.

The present invention relates to a device for relocating a lower jaw relative to an upper jaw, especially according to the principle of a Herbst hinge, as defined in the preamble of claim 1. A telescopically extensible device of the kind of a Herbst hinge, comprising a holder with an eye mounted on each of its two ends, by means of which the device can be mounted in articulated fashion, for example on the one hand on a molar strip in the upper jaw and on the other hand on a molar strip in the lower jaw, has been known from DE 296 19 489 U1. The molar strip is usually provided for this purpose with a counter-holder with an internal thread into which a head screw can be screwed through the respective holder of the device, the articulated connection being realized by the fact that either the shaft of the head screw or a shaft, which is provided on the counter-holder and which coaxially encloses the latter's internal thread, engages the eye of the device so as to permit the latter to rotate about the respective shaft.

The operations of screwing-in and loosening the screws must be carried out in the patient's mouth and are extraordinarily difficult in view of the confined conditions and the limited access to the region laterally beside the molars, and because of the restricted visibility of that area. The screws tend to get lost easily during those operations and must then be picked from the patient's mouth with difficulty, provided they are not swallowed before.

In the case of a commercially available device having the features of the preamble of claim 1, the head screws are internal hexagon head screws, and in order to ensure that these screws will not drop off the socket wrench as the latter is moved into the patient's mouth, there has been developed for this purpose a special wrench which is provided with an outer hexagon adapted to engage the internal hexagon of the head screw and which moreover comprises a cap, which surrounds the outer hexagon at a certain distance and which encloses the head of the screw when its outer hexagon is fitted in the recess of the head so that the latter is held in two ways, from the inside and from the outside. Such a wrench is, however, extremely complex and is not always and everywhere at hand.

Now, it is the object of the present invention to open up a way of mounting the device of the before-mentioned kind in a patient's mouth in a less troublesome way and without a greater risk that the screws may get lost in the patient's mouth.

This object is achieved by a device having the features defined in claim 1. A second solution to the object is the subject-matter of independent claim 2. Advantageous further developments of the invention are the subject-matter of the sub-claims. The invention will be described hereafter with reference to a head screw with a recess that has the shape of an internal hexagon in which a matching hexagon socket wrench can be fitted. The embodiment using a hexagon is preferred. Other embodiments, especially such using a square or triangular socket wrench, are likewise suited.

The device according to the invention uses a head screw where at least one of the surfaces of the recess in its head, that define the preferred internal hexagon, forms with the longitudinal axis of the head screw an outwardly opening small angle different from 0°. A recess of that kind tapers from the outside toward the inside, When a conventional two-legged, bent-off hexagon socket wrench, which is defined by surfaces extending in parallel to the longitudinal axis of its legs, is introduced into the tapering internal hexagon of the head screw, it eventually gets wedged whereby the head screw is secured from sliding off the hexagon socket wrench unintentionally. Once the thread of the head screw grips in the internal thread of the counter-holder, the socket wrench can be withdrawn from the head screw and can be inserted once more in the hexagonal recess in a different angular position to continue the screwing-in operation.

The second solution according to the invention uses a head screw whose head is preferably provided with a recess in the form of a conventional internal hexagon defined by axially parallel surfaces. For turning that head screw, a likewise bent-off two-legged hexagon socket wrench, having a shorter and a longer leg, is used. In the case of that wrench, however, the outer hexagon of the shorter and/or the longer leg is defined by surfaces of which at least one encloses, with the longitudinal axis of the shorter or the longer leg, a small angle different from 0° so that the respective leg tapers towards its tip. In this case, too, the socket wrench is inserted into the recess of the head until it is wedged therein. The difference between that solution and the solution according to claim 1 lies in the fact that in the case of the solution according to claim 1 the wedging effect occurs at the tip of the socket wrench, while in the case of the solution according to claim 2 it occurs on the outer edge of the recess in the head. A special advantage of the solution according to claim 1 over the solution according to claim 2 is seen in the fact that a commercially available socket wrench can be used, whereas in the case of claim 2 the socket wrench required, while being modified, is considerably less complex than that used according to the prior art.

In principle, it is sufficient if only one of the surfaces that surround the recess in the head of the screw, or in the solution according to claim 2, only one of the surfaces that define the area of engagement of the socket wrench, encloses with the longitudinal axis of the head screw or with the longitudinal axis of the respective leg of the socket wrench, respectively, an angle different from 0°. In that case, the best wedging effect is achieved by an angle of 2° to 6°, especially 4°. The same applies by analogy if more than one surfaces are inclined relative to the respective longitudinal axis at an angle different from 0°, provided the respective opposite surfaces extend in parallel to the respective longitudinal axis.

Preferably, only two mutually opposite surfaces enclose with the respective longitudinal axis an angle different from 0°:

In that case, the best wedging effect is achieved, both with the solution of claim 1 and with the solution of claim 2, if the angle, measured relative to the longitudinal axis, is equal to between 1° to 3°, preferably 2°, which corresponds to a total opening angle of the two inclined surfaces of between 2° to 6°, preferably 4°. If more than one pair of opposite surfaces, or all surfaces, are inclined relative to the respective longitudinal axis, the same applies by analogy.

The invention is especially suitable for a device as disclosed by Utility Patent File No. FOE1E034DEU entitled “Device for relocating a lower jaw relative to an upper jaw” filed the same day as the present application.

Two exemplary embodiments of the invention are illustrated in the attached drawings in which:

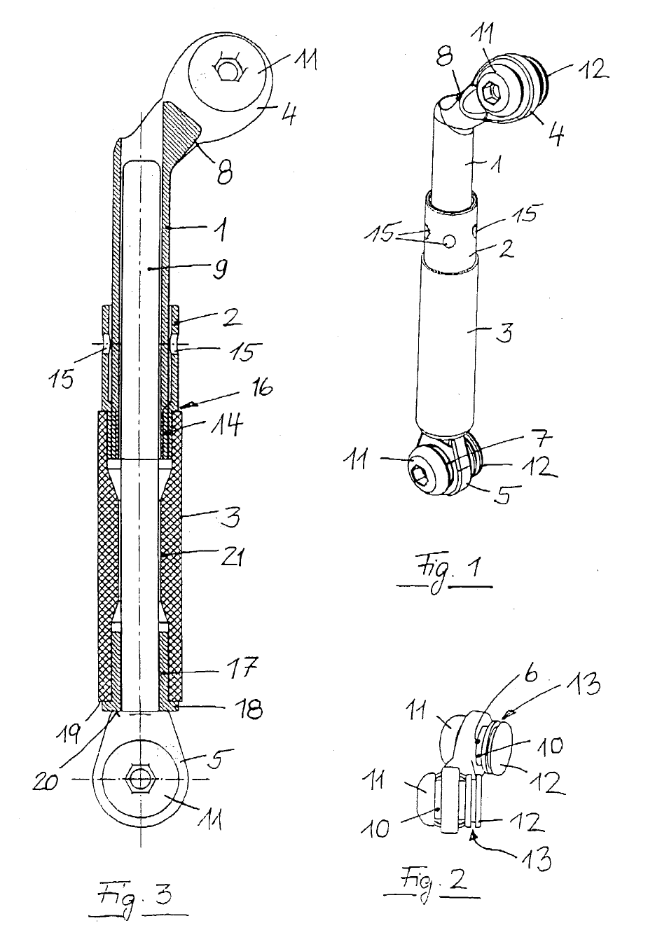

FIG. 1 shows an oblique view of a device according to the invention;

FIG. 2 shows the same device, viewed from its one end;

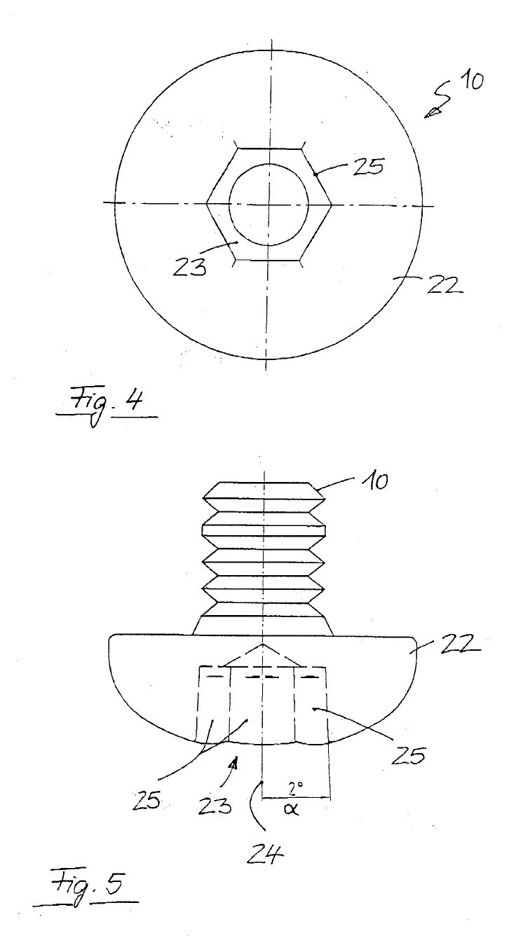

FIG. 3 shows a lengthwise section through the same device:

FIG. 4 shows a detail, namely a top view of the head of a head screw used in the device;

FIG. 5 shows a side view of the head screw of FIG. 4;

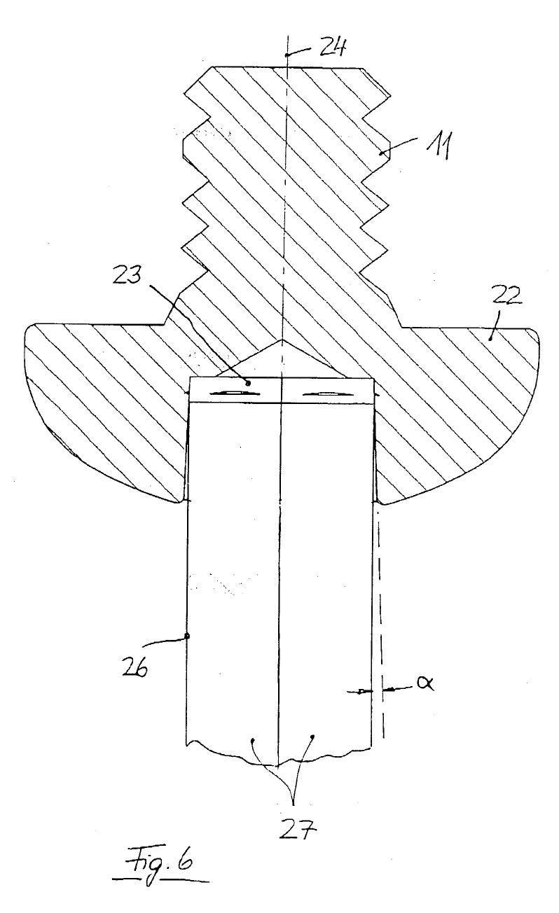

FIG. 6 shows a lengthwise section through the head screw of FIG. 5, with fitted hexagon socket wrench;

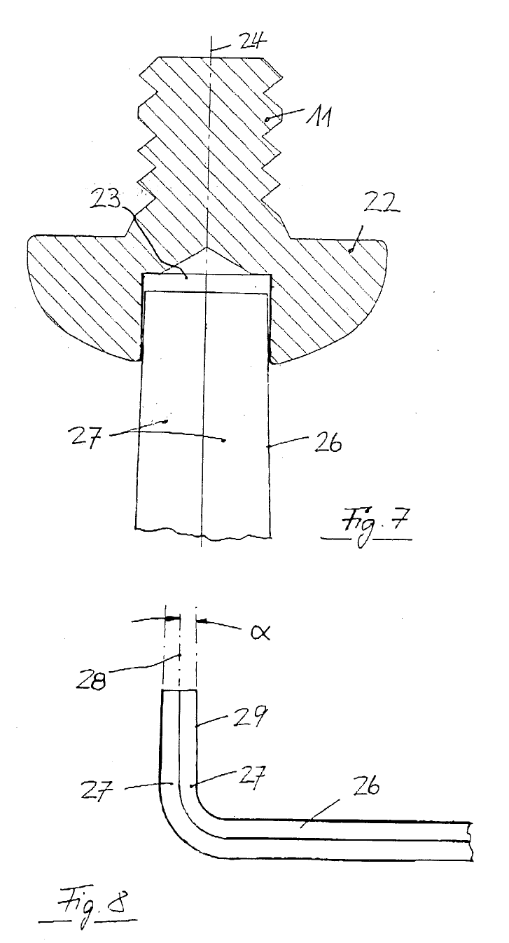

FIG. 7 shows a view similar to that of FIG. 6, but of a modified embodiment; and

FIG. 8 shows a bent-off hexagon socket wrench as used in the second embodiment.

The device illustrated in FIGS. 1 to 6 comprises a thinner first sleeve 1 screwed into a thicker sleeve 2. Mounted to the second sleeve 2 is a third sleeve 3, made from a plastic material of a kind which is capable of dampening impacts, especially from an elastomeric plastic material. In order to allow the device to be mounted in a patient's mouth on the upper jaw and on the lower jaw, a first holder in the form of an eye 6 is provided at the end of a short arm 8, which is mounted on one end of the first sleeve 1 and which extends at an obtuse angle relative to the first sleeve 1. A second holder 7, comprising a further eye 7, is mounted on a rod 9 that extends through the third sleeve 3 and into the first sleeve 1. Nuts 10 with a cylindrical shaft which are part of a counter-holder, are fitted in each of the eyes 6 and 7 in such a way that they can be turned in the eye 6 or 7, respectively. A screw 11 can be screwed into the nut from the one end. At the other end of the nut, there is provided a mounting element 12 by means of which the nut can be fixed on a molar strip, for example by welding or soldering, or by means of which it can be embedded in a plastic holder, for which purpose it comprises an angular groove 13. The plastic holder as such, which is not an element of the present invention, can be fixed on a dental arch in the patient's mouth, an operation which is known to any man skilled in the art.

In order to connect the first sleeve 1 and the second sleeve by screwing, the first sleeve 1 is provided, on its end facing away from the first holder 4, with an external thread by means of which it is screwed into a matching inner thread 14 of the second sleeve 2. The internal thread 14 is likewise provided on the end of the second sleeve 2 opposite the first holder 4. The second sleeve 2 comprises four radial bores 15 that are distributed over the circumference of the second sleeve 2 at respective angles of 90°. By inserting a pin into such a bore 15 it is possible to rotate the second sleeve 2 relative to the first sleeve 1 in order to vary the length of the device.

In the area of the internal thread 14, the outer diameter of the second sleeve 2 is reduced, forming a shoulder 16, and a final portion of the third sleeve 3 is fitted and fixed on that reduced portion, for example by bonding or shrinking. A bush 17, provided with a collar 18, is introduced into the third sleeve 3 from the other end until the collar 18 gets into contact with the end face 19 of the third sleeve. The bush 17 serves on the one hand for guiding the rod 9 in precisely fitting fashion, and on the other hand for transmitting any forces, that may suddenly occur when the patient bites his teeth together, to the third damping sleeve 3. This is so because, when the patient bites his teeth together, the rod 9 is pushed into the sleeves 1 to 3 until a stop 20, provided on the second holder 5, comes to abut against the collar 18. This impact is dampened by the third sleeve 3 to such an extent that it will not have any detrimental effects on the teeth, via the holders 4 and 5.

The inner clearance of the central portion 21 of the third sleeve 3 is so narrow that that portion contributes, just as the first sleeve 1, toward guiding the rod 9 although, compared with the bush 17, a little more play is allowed for the rod 9 in order to ensure easy moving conditions.

The head screw 11 comprises a head 22 with a recess 23 in the form of an internal hexagon defined by six surfaces 25, that extend at a small angle of 2° relative to the longitudinal axis 24 of the head screw 11. A conventional bent-off hexagon socket wrench 26, whose six surfaces 27, forming the outer hexagon, extend in parallel to its longitudinal axis 28, are wedged during insertion into the recess 23 before it reaches the end of the recess 23, as illustrated in FIG. 6. As a result of that wedging effect, the head screw 11 can be guided to the nut 10 and can be turned in the patient's mouth without getting lost.

The other embodiment of the invention illustrated in FIGS. 7 and 8 differs from the embodiment illustrated in FIGS. 1 to 6 only in that the recess 23 in the head 22 is defined by surfaces 25 that extend in parallel to the longitudinal axis 24 of the head screw. The tool used for the head screw 11 consists in that case of a bent-off hexagon socket wrench 26 which is defined on a shorter leg 29 by six surfaces 27 that taper toward the tip of the shorter leg 29 at an angle of 2° relative to its longitudinal axis 28. The wedging effect occurs in this case in the area of the outer edge of the recess 23, between the socket wrench 26 and the head screw 11.

List of reference numerals:

1 First sleeve

2 Second sleeve

3 Third sleeve

4 First holder

5 Second holder

6 Eye

7 Eye

8 Arm

9 Rod

10 Nut

11 Head screw

12 Mounting element

13 Angular groove

14 Internal thread

15 Bores

16 Shoulder

17 Bush

18 Collar

19 End face of 3

20 Stop

21 Central portion of 3

22 Head

23 Recess

24 Longitudinal axis of the head screw

25 Surfaces

26 Socket wrench

27 Surfaces of 26

28 Longitudinal axis of 26

29 Shorter leg

1. A device for relocating a lower jaw relative to an upper jaw, which is extensible in the way of a telescope and which comprises on each of its ends a holder (3, 4) with an eye (6, 7) through which the device can be mounted by means of a head screw (11) on a counter-holder (10), which latter is provided for this purpose with an internal thread matching the thread of the head screw (11), the head screw (11) comprising, for engagement with a socket wrench whose contour in the socket area is configured in the form of a regular polygon, a matching recess (23) whose cross-section likewise exhibits the shape of a rectangular polygon, characterized in that at least one of the surfaces (25) surrounding the recess (23) encloses with the longitudinal axis (24) of the head screw (11) a small angle (α) different from 0° that opens toward the outside.

2. A device for relocating a lower jaw relative to an upper jaw, which is extensible in the way of a telescope and which comprises on each of its ends a holder (3, 4) with an eye (6, 7) through which the device can be mounted by means of a head screw (11) on a counter-holder (10), which latter is provided for this purpose with an internal thread matching the thread of the head screw (11 ), in combination with a bent-off socket wrench (26) having two differently long legs and, in the socket area, a contour configured in the form of a regular polygon, with the head (22) of the head screw (11) comprising, for engagement by that socket area, a matching recess (23) whose cross-section likewise exhibits the shape of a rectangular polygon and which is defined by axially parallel surfaces, characterized in that at least one of the surfaces (27) defining the socket area of the shorter and/or the longer leg (29) of the socket wrench (26) encloses with its longitudinal axis (28) a small angle (α) different from 0° so that the respective leg (29) tapers toward its tip.

3. The device as defined in claim 1 or claim 2, characterized in that the polygon is a hexagon.

4. The device as defined in claim 1, 2 or 3, characterized in that there are two oppositely arranged such surfaces (25, 27) and that the angle (α) different from 0° is enclosed between each of said two oppositely arranged surfaces and the respective longitudinal axis (24 or 28).

5. The device as defined in claim 4, characterized in that the angle (α) is 1° to 3°.

6. The device as defined in claim 4, characterized in that the angle (α) is 2°.

7. The device as defined in claim 1, 2 or 3, characterized in that in the case where the surfaces (25, 27), which enclose with the respective longitudinal axis (24 or 28) a small angle (α) different from 0°, are arranged opposite to surfaces which extend in parallel to the longitudinal axis (24 or 28), the angle (α) is 2° to 6°.

8. The device as defined in claim 1, 2 or 3, characterized in that in the case where the surfaces (25, 27), which enclose with the respective longitudinal axis (24 or 28) a small angle (α) different from 0°, are arranged opposite to surfaces which extend in parallel to the longitudinal axis (24 or 28), the angle (α) is 4°.
